(19) United States
(12) Patent Application Publication
(10) Pub. No.: US 2026/0296049 A1
(43) Pub. Date: Oct. 1, 2026

(54) ANALYZING CALIBRATION DATA TO DETECT AND CORRECT MAINTENANCE ISSUES

(71) Applicant: Xerox Corporation, Norwalk, CT (US)

(72) Inventors: Stuart A. Schweid, Pittsford, NY (US); Ka Fung, Rochester, NY (US); Shawn P. Updegraff, Fairport, NY (US); Christine A. Steurrys, Williamson, NY (US)

(21) Appl. No.: 19/090,690

(22) Filed: Mar. 26, 2025

(51) Int. Cl. B41J 2/21; B41J 2/175; G06T 7/00

(52) U.S. Cl. CPC B41J 2/2142; B41J 2/17566; B41J 2/2135; B41J 2/2139; G06T 7/0004; G06T 2207/30144

(57) ABSTRACT

Systems and methods for detecting printhead misalignment are disclosed. A method includes receiving, for each of multiple printheads, multiple tone response curves (TRCs), each TRC associated with an inkjet of the printhead. The method further includes decomposing each TRC into a linear component and a non-linear component. The method further includes determining, for each printhead, a degree of misalignment based on the non-linear component of the TRCs associated with the printhead. The method further includes determining, for each printhead, a statistical deviation of the degree of misalignment from a norm for the multiple printheads. The method further includes, in response to the statistical deviation of the degree of misalignment exceeding a misalignment threshold, triggering an action.

### BACKGROUND

Drop-on-demand inkjet technology for producing printed media has been employed in commercial products such as printers, plotters, and facsimile machines. Generally, an inkjet image is formed by selectively ejecting ink drops from multiple inkjets, which are arranged in one or more printheads, onto an image receiving surface. In a direct inkjet printer, the printheads eject ink drops directly onto the surface of a print medium such as a paper sheet or a continuous paper web. In an indirect inkjet printer, the printheads eject ink drops onto the surface of an intermediate image receiving member such as a rotating imaging drum or belt. During printing, the printheads and the image receiving surface move relative to one another, and the inkjets eject ink drops at appropriate times to form an ink image on the image receiving surface. A controller in the printer generates electrical signals, also known as firing signals, at predetermined times to activate individual inkjets in the printer. The ink ejected from the inkjets can be liquid ink, such as aqueous, solvent, oil based, UV curable ink or the like, which is stored in containers installed in the printer. Alternatively, some inkjet printers use phase change inks that are loaded in a solid form and delivered to a melting device. The melting device heats and melts the solid phase change ink to a liquid form that is supplied to a printhead for printing as liquid drops onto the image receiving surface.

During operation, the amount of ink actually ejected from each inkjet may vary somewhat, due to manufacturing differences, wear over time, and other factors. To compensate for the jet-to-jet variation, printed test patterns are occasionally evaluated for uniformity. Each jet is then calibrated, based on its contribution to the test pattern, so that a uniform test pattern can be generated. However, this calibration process may obscure latent maintenance issues, particularly emerging maintenance issues, masking the need to perform corrective actions. Waiting too long to perform corrective action can result in reduced quality, excess downtime and generally increased total cost of owning and operating print devices. This document describes improvements that address at least some of the issues described above.

### SUMMARY

The present disclosure concerns implementing systems and methods for detecting latent maintenance issues. A method for detecting printhead misalignment in a print device includes receiving, for each of multiple printheads, multiple tone response curves (TRCs), each TRC associated with an inkjet of the printhead. The method further includes processing each of the multiple TRCs to decompose each TRC into a linear component and a non-linear component. The method further includes determining, for each printhead, a degree of misalignment based on the non-linear component of the TRCs associated with the printhead. The method further includes determining, for each printhead, a statistical deviation of the degree of misalignment from a norm for the multiple printheads. The method further includes, in response to the statistical deviation of the degree of misalignment exceeding a misalignment threshold, triggering an action.

Implementations of the disclosure may include one or more of the following optional features. In some examples, the method further includes monitoring, for each printhead of the multiple printheads, changes in the degree of misalignment over time and, in response to a change in the degree of misalignment exceeding a change threshold, triggering a second action. Receiving the multiple TRCs may include receiving TRCs for each printhead of a fleet of print devices. Triggering the action may include causing re-registration of one or more of the printheads. Receiving the multiple TRCs may include receiving TRCs associated with inkjets corresponding to a stitch zone between printheads. In some examples, the plurality of printheads include printheads of a plurality of print devices, the plurality of print devices including a fleet of print devices and determining the statistical deviation of the degree of misalignment from the norm for the plurality of printheads includes determining a statistical deviation of the degree of misalignment from a norm for the fleet of print devices. The norm for the fleet of print devices may include a mean of the degrees of misalignment for the printheads of the fleet of print devices and the misalignment threshold may include three standard deviations from the mean for the fleet of print devices. In some examples, the method further includes, by the print device, using each printhead to print a test pattern on a substrate, capturing an image of each printed test pattern, and processing the captured images to generate the TRCs for the printheads. In some examples, each printhead includes a printhead of one or more printer assemblies of a fleet of print devices, each of the one or more printer assemblies of the fleet of print devices includes multiple printheads and determining, for each printhead, a degree of misalignment includes determining a degree of misalignment with respect to an adjacent printhead of the printer assembly.

In another aspect, a method includes, by a processor, receiving, for each of multiple printheads of a fleet of print devices, a spatially varying tone response curve (sTRC), the sTRC including calibration information for each of multiple inkjets of the printhead. The method includes applying a linear regression to the calibration information for each inkjet to determine a calibration factor for each inkjet. The method further includes, based on one or more of the calibration factors, determining an overall calibration factor for each of the multiple printheads. The method further includes, determining, for each printhead, a statistical deviation of its overall calibration factors from a norm for the multiple printheads. The method further includes, in response to the statistical deviation of the overall calibration factor exceeding a calibration threshold, triggering an action.

Implementations of the disclosure may include one or more of the following optional features. In some examples determining the overall calibration factor for each of the multiple printheads includes: (i) determining whether each inkjet is associated with a stitch zone, and (ii) averaging the calibration factors for inkjets that are not associated with the stitch zone. In some examples, determining whether each inkjet is associated with a stitch zone includes: (i) after determining the calibration factor for each inkjet, determining a non-linear coefficient for each inkjet based on residual calibration information, and (ii) in response to the non-linear coefficient exceeding a threshold, determining that the inkjet is associated with the stitch zone. In some examples, the method further includes, (i) after determining the calibration factor for each inkjet, determining a non-linear coefficient based on residual calibration information, (ii) determining whether each inkjet is associated with a stitch zone based on a position of the inkjet in the printhead, (iii) and, in response to an inkjet that is not associated with a stitch zone having a non-linear component that exceeds a threshold, triggering a second action.

In some examples, the method further includes determining, for each inkjet of each printhead, a statistical deviation of its calibration factor from a norm for the inkjets of the printhead and, in response to the statistical deviation of the calibration factor exceeding an inkjet calibration threshold, triggering a second action. The method may further include determining, for each printhead, a rate of ink usage based on the overall calibration factor for the printhead. The method may further include determining, for each printhead, a statistical deviation of the rate of ink usage from the norm for the multiple printheads. The method may further include, in response to the statistical deviation of the rate of ink usage exceeding a usage threshold, triggering a second action. Triggering the second action may include adjusting a voltage applied to one or more of the printheads having the rate of ink usage exceeding the usage threshold. Triggering the second action may include adjusting a halftoning process associated with one or more inkjets of one or more of the printheads having the rate of ink usage exceeding the usage threshold. In some examples, the method further includes, by at least one print device of the fleet of print devices, using each printhead to print a test pattern on a substrate, capturing an image of each printed test pattern, and processing the captured images to generate the sTRCs for the printheads.

### BRIEF DESCRIPTION OF THE DRAWINGS

The present solution will be described with reference to the following drawing figures, in which like numerals represent like items throughout the figures.

FIG. 1 provides an illustration of components of an example print device.

FIG. 2 shows a schematic diagram of an example printer assembly.

FIG. 3 is a block diagram of a substrate passing under printhead assemblies in a CMYK print system.

FIG. 4 shows a graph displaying example calibration data assembly.

FIG. 5 shows an example fleet of print devices.

FIG. 6 shows a flowchart of an example method of detecting printhead misalignment.

FIG. 7 shows a flowchart of another example method.

FIG. 8 shows a flowchart of example service decisions.

FIG. 9 provides a block diagram of an illustrative architecture for a computing device.

### DETAILED DESCRIPTION

In the various embodiments, the devices, methods and systems of the present disclosure relate to marking systems of printers that include printheads. Specifically, the present disclosure relates to print devices that include printheads configured to eject ink onto substrates to form desired images. In particular, the present disclose relates to analyzing calibration data associated with inkjets, printheads, print devices, and/or fleets of print devices to uncover latent maintenance issues and cause remedial actions to be taken.

A typical inkjet printer uses one or more printheads. Each printhead typically contains an array of individual nozzles (known as inkjets) for ejecting drops of ink across an open gap to a substrate to form an image. Individual piezoelectric, thermal, acoustic, or other actuators generate mechanical forces that expel ink through an orifice from an ink-filled conduit in response to an electrical voltage signal, sometimes called a firing signal. The magnitude, or voltage level, of the signals affects the amount of ink ejected in each drop. An inkjet printer forms a printed image in accordance with image data by printing a pattern of individual ink drops at particular locations on the image receiving member. The locations where the ink drops land are sometimes called “ink drop locations,” “ink drop positions,” or “pixels.” Thus, a printing operation can be viewed as the placement of ink drops on a substrate in accordance with image data. Actual performance of each inkjet in response to a firing signal may vary due to manufacturing differences and other reasons. To address this, inkjet printers may obtain calibration data, e.g., through an empirical process, and apply the calibration to the operation of the inkjet and/or printhead to compensate for the differences in inkjet performance.

As discussed in this document, a common form of calibration data is known as a Tone Response Curve (TRC). In its most basic form, a tone response curve for a particular inkjet (or for a set of neighboring inkjets) indicates the relationship between (i) a requested amount of ink to be applied to a substrate and (ii) the actual amount of ink applied to the substrate. That is, a TRC may be a two-dimensional graph that models, for each requested amount of ink to be applied to a substrate, the amount of ink that will actually be output (or the effect the ink that is actually output will have on the substrate). Armed with this information, the print device can adjust the requested amount of ink to achieve a desired actual result. For example, for a simple case where the TRC indicates that particular inkjets always eject 2 percent less ink than required to achieve a certain intensity on the substrate, the print device can increase the amount of ink from those inkjets by approximately 2 percent to compensate. Conversely, if particular inkjets always eject 2 percent more ink than required, the print device can decrease the amount of ink from those inkjets by approximately 2 percent to compensate. When all inkjets are calibrated and compensated for in this way, the actual output of the print device closely approximates the desired output. Thus, deviations from expected inkjet performance can be effectively addressed.

One technique to determine the actual output of the inkjets is for the print device to measure or sense a sample printed output on a substrate. For example, a print device may include a high-resolution camera that is capable of sensing small variations in intensity. The print device may print test patterns which are then captured by the camera/sensor and analyzed to determine actual inkjet performance. Test patterns may vary in intensity (e.g., gray value) and/or color (e.g., cyan, magenta, yellow, black) to provide a rich set of examples from which to determine the calibration data. In some examples, calibration data (e.g., TRCs) are obtained for various different types of substrates to account for variations of inkjet performance with respect to particular substrates. In some examples, the print device may be equipped with a camera configured to continually capture images of printer output, e.g., both during normal operation and while printing test patterns, to determine the actual output of the inkjets on the substrate. The print device may identify portions of printed output that are suitable for accurately determining inkjet performance, e.g., based on the image data used to form the output. For example, the print device may monitor image data for a naturally occurring uniform region of color and automatically obtain an image of that region to determine the performance of inkjets used to print that region. Over time, this stochastic process may provide sufficient information for the print device to determine calibration data for all inkjets.

The disclosed systems and methods are not limited to TRCs or the particular techniques for obtaining TRCs disclosed above. Other forms of calibration data are also within the scope of this disclosure. As noted above, calibrating and compensating for individual inkjets, printheads, and/or printer assemblies can mask latent maintenance issues. The disclosed systems and methods analyze calibration data to discover latent maintenance issues and trigger remedial action earlier than previously possible.

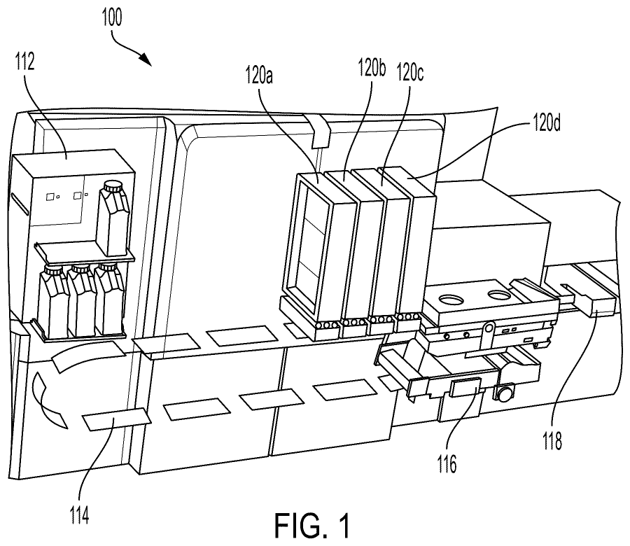

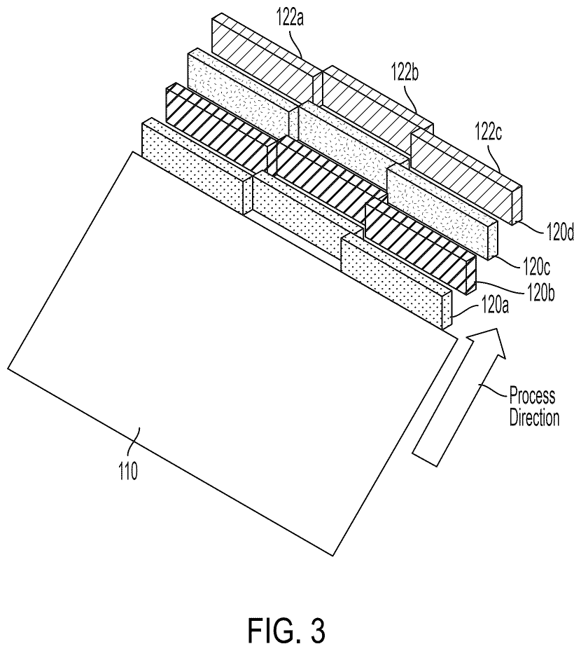

FIG. 1 provides an illustration of components of an example print device 100. As shown, print device 100 includes an ink source 112. In the case of a color printer, the ink source may include colors used in a subtractive color model for printing, such as cyan (C), magenta (M), and yellow (Y), as well as a key (K), which may be black. A substrate (110, FIG. 3), such as paper, enters the print device 100 from a substrate supply and handling subsystem (not shown) and follows substrate path 114. Print device 100 guides the substrate 110 along the substrate path 114 in a direction known as the process direction. The substrate 110 is guided past one or more printer assemblies, e.g., 120a-120d, which apply ink to the substrate 110. As shown, the print device 100 may include four printer assemblies 120, one for each color (and key). The print device may include additional substrate handling/management components such as a duplexer 116, which causes the substrate 110 to pass by the printer assemblies 120 a second time, so that the printer assemblies can apply ink to a second side of the substrate 110. Print device 100 may also include additional processing components, such as a fuser 118 which helps fix the ink to the substrate 110 or any of several other finishing components, such as a stapler or hole puncher. Furthermore, print device 100 may include one or more cameras configured to capture images of the substrate 110 after printing, e.g., for calibration and/or quality-control purposes.

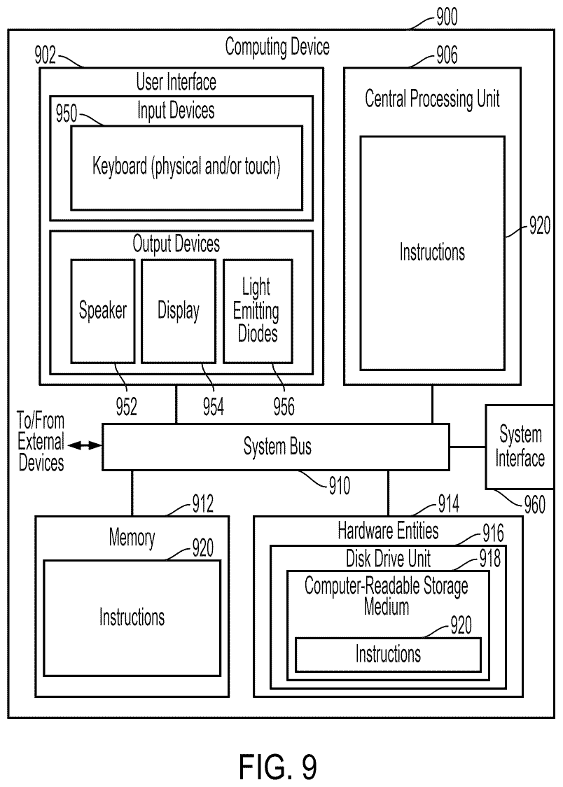

Print device 100 may have associated software (e.g., driver software) that is configured to control operations of the print device 100 and its components (e.g., printheads 122 and associated inkjets). In some examples, print device 100 includes a microcontroller or processor with embedded software and/or a memory containing programming instructions that is configured to control operations of the print device 100 and its components. In other examples, at least some operations are controlled by one or more processors, memory devices, and programming instructions that are located remotely from print device 100, and which is communicatively connected to the print device 100 via one or more communication paths such as a network. The local and/or remote processors or controllers may be the same as or similar to computing device 900 of FIG. 9. In some examples, calibration software may be executed, either locally or remotely, to generate and/or store calibration data and/or adjust operation of the printheads 122 and/or inkjets based on the calibration data, e.g., to compensate for detected variations in inkjet performance.

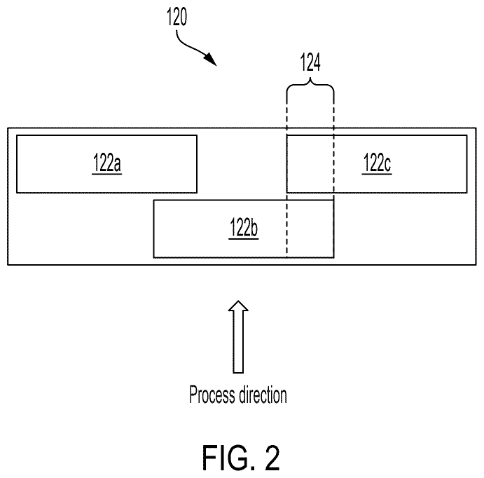

FIG. 2 shows a schematic diagram of an example printer assembly 120. As shown, the process direction, i.e., the direction that the substrate 110 passes by the printer assembly 120, is from the bottom of the diagram toward the top of the diagram. As described above, the substrate 110 may also pass in the opposite direction, e.g., after being reversed by a duplexer or similar component. In either case, the cross-process direction is either left-to-right or right-to left in the diagram, i.e., in a transverse direction with respect to the process direction. Each printer assembly 120 may include multiple printheads (e.g., 122a-122c). As shown, the printer assembly 120 includes three printheads 122. However, in other embodiments, printer assemblies 120 may include any number of printheads 122. Each printhead 122 in turn may include multiple separate inkjets. In some examples, each printhead 122 includes hundreds or even thousands of individual inkjets. For example, Xerox® W Series Print Bar Marking System contains 5,544 active nozzles across a 4.5″ printing array. Each individual inkjet corresponds to an area on the substrate 110 onto which the inkjet's ink is ejected. In some examples, these areas are referred to as pixels, and each inkjet corresponds to particular pixels of substrate 110. In some examples, sets of neighboring inkjets may act in concert to eject ink onto a single pixel. In that configuration, each pixel corresponds to a particular set of neighboring inkjets. In an extreme case, all inkjets of a printhead 122 act in concert. For simplicity, this document will describe printheads 122 having individually controlled and individually calibrated inkjets, each inkjet corresponding to a particular pixel on the substrate. However, the disclosure applies equally to other configurations of printheads 122 and inkjets.

In some examples, the printheads 122 are disposed substantially in a row along the cross-process direction so as to cover the entire cross-process width of the substrate 110. That is, multiple printheads 122 may be stitched together within a wider printer assembly 120. To avoid gaps in coverage, adjacent printheads 122 may overlap by a distance 124 in the cross-process direction. In this configuration, ink ejected from each of the adjacent printheads may interleave on the substrate 110 in a region known as a “stitch zone.” While this configuration avoids gaps in coverage, the stitch zone may include pixels that correspond to inkjets from different printheads 122. Thus, misalignment of adjacent printheads 122 with respect to each other may, if not mitigated, result in other undesirable artifacts in the stitch zone, including (but not limited to) non-uniform intensity. In some examples, the print device 100 includes the capability to perform automatic alignment of adjacent printheads 122 within a tolerance. For example, printer assembly 120 may include one or more mechanical actuators for adjusting the position of individual printheads 122 within a printer assembly 120 (e.g., motors, biasing elements, etc.). Print device 100 may be able to detect printhead misalignment, e.g., by comparing test pattens (e.g., dashes) produced by adjacent printheads 122 and iteratively adjusting the position of printheads until the detected error is less than a threshold.

That is, the test patterns represent the orientation of each printhead 122. Thus, the geometric alignment of adjacent printheads 122 can be inferred from the degree of alignment of test patterns produced by the printheads 122. Print device 100 may mechanically adjust the orientation of one or more printheads 122 until the test patterns indicate a sufficiently small misalignment. However, a subsequent calibration process, e.g., as discussed above, may still be required to achieve uniform intensity across all printheads 122 (within an intensity tolerance). In some examples, printheads 122 are field replaceable. In this case, the print device 100 may automatically perform the alignment after a printhead 122 is replaced. Any residual geometric misalignment between printheads 122 may be addressed by a subsequent intensity calibration (thus masking the degree of residual misalignment).

FIG. 3 illustrates, in schematic form, that a printer may pass a substrate 110 under four printhead assemblies 120a-120d, each of which includes multiple printheads 122 that apply ink of particular colors to a substrate. For example, in a CMYK color system, printhead assembly 120a may hold and apply black ink (K), printhead assembly 120b may hold and apply cyan ink (C), printhead assembly 120c may hold and apply magenta ink (M), and printhead assembly 120d may hold and apply yellow ink (Y). As described above, each printhead assembly 120 may include multiple printheads 122. In the example shown, each printhead assembly such as printhead assembly 120d includes three printheads 122a, 122b, and 122c. Each printhead 122 of a printhead assembly 120 is oriented to be parallel to the other printheads 122 of the printhead assembly 120. The printheads 122 of a printhead assembly 120 may be positioned in a row so that the location of an edge of one printhead (such as printhead 122a) matches the location of an edge of its neighboring printhead (such as printhead 122b). Alternatively, the printheads may be positioned so that the edges of neighboring printheads (such as printheads 122a and 122b) overlap with each other in an area that is sometimes referred to as a “stitch zone.” The use of a stitch zone can help to avoid white streaks that may result from each printhead's housing causing separation between the nozzles of neighboring printhead 122.

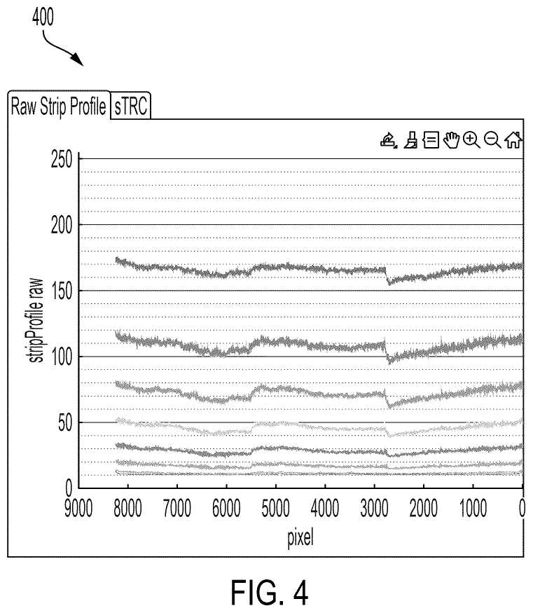

FIG. 4 shows a graph 400 displaying example calibration data. The calibration data was obtained from a test pattern that includes eight separate regions, each region corresponding to a distinct intensity (gray value). Graph 400 includes eight traces, each trace corresponding to one of the gray values. In some examples, the test pattern may include a greater or smaller number of separate regions (and distinct gray values). A greater number of distinct gray values may require printing and processing a greater number of test patterns, using more resources (e.g., substrate and time). Furthermore, small differences in gray values may be difficult to distinguish between. Therefore, test patterns including test patterns with only small differences in gray values may not result in additional useful information. However, a smaller number of distinct gray values may result in a less rich data set, possibly requiring more interpolation when correcting for desired gray values that are far from the gray values of the test patterns. Thus, the number of gray values in a test pattern may represent a compromise between conserving resources and obtaining more comprehensive data and may depend on an expected ability to accurately interpolate between gray values.

The X axis of graph 400 indicates a pixel position in the cross-process direction. The Y axis indicates a measured intensity at the pixel position. As described above, the intensity may be measured by a camera, e.g., incorporated into the print device 100. The example data was obtained from a print device 100 including a printer assembly 120 having three printheads 122. In this example, each printhead includes 5,500 inkjets, with pairs of neighboring inkjets corresponding to one pixel. Thus, each individual printhead 122 corresponds to 2,750 pixels. Stitch zones between adjacent printheads 122 (i.e., where inkjets of adjacent printheads 122 overlap) can be seen around pixels 2,750 and 5,500. In this example, the stich zone is about 55 pixels (110 inkjets) wide. That is, 55 inkjets at one end of a printhead 122 overlap with 55 inkjets at the corresponding end of the adjacent printhead 122. In this example, the stitch zone represents 2 percent of the width of the printhead 122 (in pixels). However, the invention is not limited to the printer assembly 120, printhead 122, and inkjet configuration depicted in graph 400. That is, printer assemblies may have greater or fewer numbers of printheads 122, printheads may have greater or fewer than 5,500 inkjets, each pixel may correspond with a greater or fewer number of individual inkjets, and the relative size of the stitch zone (e.g., with respect to a printhead) may all vary from this particular example configuration.

In some examples, calibration data is obtained separately for each of several colors. For example, a test patten may include regions of cyan, magenta, yellow, and black. Furthermore, each region may include sub-regions of different gray values. That is, the test pattern may include, e.g., eight gray values of cyan, eight gray values of magenta, eight gray values of yellow, and eight gray values of black. In this case, graph 400 may represent calibration data obtained for one color. Thus, calibration data may include a similar graph for each other color. The number of gray values used for each color may be the same as each of the other colors or may be color dependent.

The calibration data may be converted into a set of spatially varying Tone Response Curves (sTRCs) for each printhead 122. Spatially varying means that the TRC for one pixel location may be different than the TRC for another pixel location. That is, rather than a single TRC for the entire printhead 122, each cross-process location (e.g., pixel) has an associated function (e.g., in the form of a curve) that models the relationship between each requested amount of ink to be applied to a substrate (e.g., a gray value) and the amount of ink that will actually be output (e.g., to compensate for measured non-uniformity). That is, when the print device 100 converts image data to firing signals, the firing signals for inkjets associated with a particular cross-process pixel position are adjusted according to the TRC for the particular cross-process pixel position and the desired gray value. The curve may be generated based on the calibration data and may include interpolation between measured gray values. Interpolation may be linear, or according to a polynomial or spline fit, for example. In some examples, calibration data includes spatially varying TRCs for each possible substrate, and the print device 100 adjusts the firing signals based on the TRC for the substrate currently in use.

As described above, calibration information, such as TRCs, are used to mitigate cross process non-uniformities of a printer. Measured variations in uniformity are compensated for by adjusting the commanded gray values of the printed image and, thus, the volume of ink that is actually output. Compensation may include, for inkjets associated with lower measured intensity, increasing the voltage of and/or the rate of firing signals and, for inkjets associated with higher measured intensity, decreasing the voltage of and/or the rate of firing signals. That is, adjusting the voltage of and/or the rate of firing signals causes a greater or lesser amount of ink to be ejected over a period of time.

TRCs may be generated from time to time, on demand, and/or according to a maintenance schedule. In some examples, portions of TRCs may be generated stochastically during normal operation of the print device 100 by opportunistically identifying suitable regions of printed output for analysis. In some examples, TRCs associated with a printhead 122, a printer assembly 120, a print device 100 and/or a fleet of print devices 100 may be analyzed to uncover latent maintenance issues.

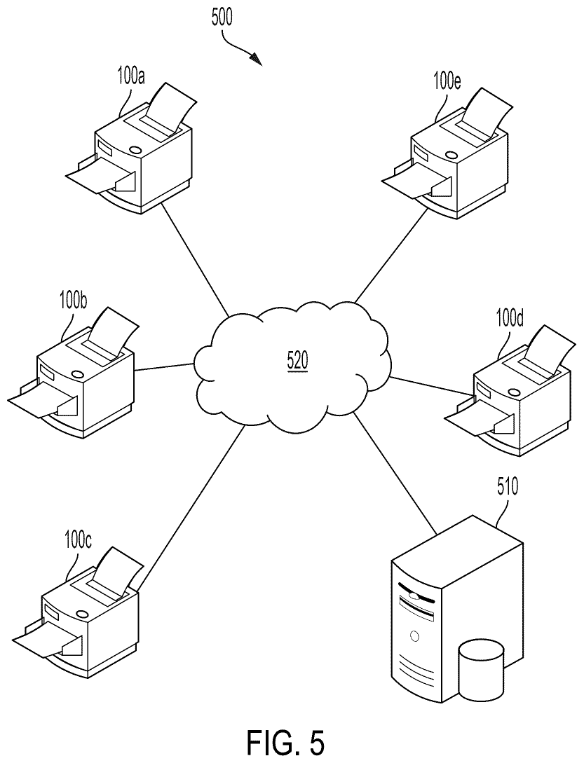

FIG. 5 shows an example fleet 500 of print devices 100a-e, each of which has associated calibration information (e.g., spatially varying TRCs, as described above). The fleet 500 can be any size, from a single print device to hundreds, thousands, or even more. As shown, the fleet 500 includes multiple print devices 100 that are in operational use, e.g., supporting a printing enterprise, and are communicatively coupled through network 520. FIG. 5 also shows an analysis system 510 which is communicatively coupled to the print devices 100 and is configured to process the calibration information associated with the fleet 500 to uncover latent maintenance issues. In some examples, the fleet 500 goes beyond print devices 100 in current operational use by an enterprise. That is, analysis system 510 may process calibration information associated with print devices 100 across multiple enterprises and/or print devices 100 that may not be currently in operational use. That is analysis system 510 may process historical information, e.g., to identify trends over time, and/or analysis system 510 may process cross-enterprise information to detect differences between installations. In some examples, analysis system 510 is associated with a manufacturer of print devices 100, and analysis system 510 is configured to process information associated with many or all print devices 100 sold or leased by the manufacturer to multiple enterprises and includes historical information of print devices 100 sold or leased by the manufacturer over long periods of time.

In some examples, analysis system 510 processes calibration information, such as spatially varying TRCs of the fleet 500 of print devices 100, to determine norms for the fleet 500 and deviations from norms within the fleet 500. For example, analysis system 510 may process TRCs from the entire fleet (or substantially the entire fleet) to determine typical correction factors applied to inkjets. As described above, a TRC may include the relationship (e.g., for a particular pixel) between commanded output and expected output for each of multiple gray values. Analysis system 510 may mathematically process each TRC to obtain, for each inkjet, a single scalar correction factor representing an estimate of the correction typically applied to the inkjet during printing. For example, analysis system 510 may apply a simple linear regression (e.g., using ordinary least squares) to each TRC to determine a slope of the calibration curve. The determined slope may represent a correction factor applied to the inkjet across many or all gray values.

In some examples, analysis system 510 may also compute a goodness-of-fit to the linear relationship, e.g., to determine how well the correction factor represents the TRC. For example, the analysis system 510 may determine a deviation of the TRC from a simple linear relation by examining the residuals (after the linear component has been removed). For example, analysis system 510 may decompose the TRC into linear and non-linear components and compute a non-linear coefficient based on a statistical variance of the residuals, e.g., including summing the square of each residual. In this way, analysis system 510 may identify inkjets having a large non-linear coefficient, indicating that the associated TRC does not fit well to a simple linear model. That is, analysis system 510 may identify inkjets whose associated TRC has statistically significant deviation from a simple linear relationship.

Inkjets associated with a stitch zone between printheads 122 may have a significant non-linear coefficient, e.g., due to the joint contribution to the TRC from overlapping inkjets of adjacent printheads 122, contributions to the TRC from any misalignment between the printheads 122, and other factors. However, inkjets that (i) are not associated with a stitch zone and which also (ii) are associated with calibration information having a significant non-linear coefficient may indicate a latent maintenance issue for that inkjet. In response to identifying such an inkjet, the analysis system 510 may trigger an action. Actions may include generating an alert to replace the printhead 122 that includes the identified inkjet. The alert may include illuminating a light on the print device 100, displaying a message on the print device 100, and/or generating an e-mail or text message, among other actions. In some examples, the analysis system 510 may prevent further printing until the printhead 122 has been replaced.

In some examples, analysis system 510 determines, for each printhead 122, a single scalar value representing an estimate of the overall correction factor for the printhead 122, e.g., based on the computed correction factors for inkjets of the printhead 122. As described above, analysis system 510 may identify inkjets whose associated TRC does not fit well to a linear relation (i.e., has a large non-linear coefficient). In some examples, the system compares the non-linear coefficient to a threshold, such as three sigma deviation from a norm, to determine that the TRC does not fit well to a linear relation. Analysis system 510 may exclude such inkjets when determining the overall correction for the printhead 122. That is, analysis system 510 may deem such inkjets as not representative of the performance of the printhead 122 as a whole due to their large non-linear coefficient. Instead, analysis system 510 may compute the overall correction for the printhead 122 based on the individual correction factors of inkjets associated with a low non-linear coefficient. Alternatively (or additionally) analysis system 510 may exclude inkjets within a threshold distance of the end of the printhead, e.g., within 1 percent of the width of the printhead (in pixels). Analysis system 510 may compute the overall correction factor for the printhead 122 based on included inkjets (e.g., inkjets more than a threshold distance from the end of the printhead 122 and/or whose associated correction factor is a good fit to a linear model). Analysis system 510 may combine the correction factors for included inkjets, e.g., by computing the median, arithmetic mean, weighted mean, or other value that represents the combined contribution of the individual correction factors. The resulting overall correction factor for the printhead 122 may represent an overall correction factor applied to the printhead 122 to achieve uniform output. This correction factor may represent the typical ink drop size ejected from inkjets of the printhead 122 relative to ink drop sizes associated with other inkjets of the fleet. This may also indicate typical ink usage by the printhead 122. This ink usage may deviate from the norm for other printheads 122, including both much greater and/or much lower levels of ink usage than the norm.

In some examples, analysis system 510 performs a statistical analysis on the individual correction factors that are used to determine the overall correction factor for the printhead 122. That is, in addition to computing a mean, analysis system 510 may also determine a standard deviation, e.g., to determine a degree of variation among individual inkjet correction factors within the printhead 122. The analysis system 510 may also identify a number of outlying correction factors based on the standard deviation. For example, the analysis system 510 may determine the number of correction factors that are more than, e.g., three standard deviations from the mean. Thus, the analysis system 510 may identify printheads 122 having statistically significant variation among their individual inkjet performance. In response, the analysis system 510 may take appropriate action, such as causing the identified printhead(s) 122 to be replaced.

In some examples, analysis system 510 performs a statistical analysis on the correction factors for each of the printheads 122 of the fleet 500 of print devices 100. The statistical analysis may include computing mean, mode, median, variance, standard deviation, or similar statistically relevant quantities for the fleet 500. In this way, analysis system 510 can identify statistically outlying printheads 122. That is, analysis system 510 may identify printheads 122 whose associated correction factor is more than a threshold from a norm for printheads 122 of the fleet 500. For example, a norm for the fleet 500 of print devices 100 may be a mean of the correction factors for the printheads 122 of the fleet 500, and the analysis system 510 may identify printheads 122 whose associated correction factor is more than three standard deviations from that norm. In response to identifying such a printhead 122, the analysis system 510 may trigger an action. As described above, actions may include generating an alert to replace the printhead 122. The alert may include illuminating a light on the print device 100, displaying a message on the print device 100, and/or generating an e-mail or text message, among other actions. In some examples, the analysis system 510 may prevent further printing until the printhead 122 has been replaced. The action may also include modification or adjustments to the halftoning process to accommodate a larger or small ink drop size. For example, the print device 100 may adjust the ratio of colors applied to a pixel to increase or decrease intensity at that pixel to accommodate an off-normal correction factor. Furthermore, in some examples, the print device 100 may support independently adjusting a voltage applied to each printhead 122. In this case, the analysis system 510 may adjust the voltage applied to any or all outlying printheads 122 to bring the printhead 122 closer to the norm.

Furthermore, the analysis system 510 may identify adjacent printheads 122 having a large variation in associated correction factors. Large variation in associated correction factors may be more difficult to fully correct for uniformity within the stitch zone between the adjacent printheads 122. In some examples, the analysis system 510 performs a statistical analysis of the differences between correction factors between adjacent printheads 122 for all or most of the fleet to identify outlying differences. In other examples, the analysis system 510 simply compares each difference in correction factors of adjacent printheads 122 to a difference threshold. For example, if one printhead 122 has a correction factor that indicates average ink drop size for the printhead 122 is 10 percent lower than the mean for all printheads 122, and if an adjacent printhead 122 has a correction factor that indicates average ink drop size for the printhead 122 is 10 percent greater than the mean for all printheads, then the difference in correction factors is 20 percent. Analysis system 510 may compare this difference to a difference threshold to identify stitch zones that may benefit from maintenance. In some examples, the difference threshold is related to the standard deviation of correction factors for all printheads. For example, the difference threshold may be sqrt(2) times the standard deviation. In response to identifying a stitch zone that may require maintenance, analysis system 510 may take an action related to one or both printheads 122. For example, if the correction factor for one of the printheads 122 associated with the stitch zone is much larger than the correction factor for the other printhead 122, analysis system 510 may take an action related to the printhead associated with the larger correction factor, such as causing the printhead 122 to be replaced. If the correction factors are similar, the analysis system 510 may take an action related to both printheads 122 associated with the stitch zone. In some examples, the analysis system 510 may determine that printheads 122 within a printer assembly 120 should be rearranged. For example, the analysis system 510 may determine that the printheads 122 should be ordered according to their respective correction factors, to minimize the difference between correction factors of adjacent printheads 122. The actions taken by the analysis system 510 may be similar to those described above, including triggering a field replacement and/or preventing further printing until the field replacement occurs.

In some examples, the analysis system 510 may perform statistical analyses on calibration information collected over time to identify emerging trends. A trend may indicate deterioration of one or more components of the print device 100. For example, the analysis system 510 may track correction factors associated with printheads 122 and/or differences in correction factors associated with stitch zones to predict, in advance, when a maintenance activity may be required. In some examples, the analysis system 510 identifies parameters having a rate of change greater than a threshold, and/or which is much greater than the rate the equivalent parameter is changing elsewhere in the fleet. In some examples, the analysis system 510 projects, based on a rate of change of a parameter, such as average ink drop size, when a printhead 122 is likely to require replacement. In response, the analysis system 510 may trigger an action, such as scheduling a maintenance activity at an appropriate time. For example, the analysis system 510 may schedule preventative maintenance tasks during a non-operational period to avoid interrupting operational periods to perform the maintenance activity. In this way, the total cost of owning and/or operating the fleet 500 of print devices 100 may be reduced.

A trend may also indicate changes (wanted or unwanted) in manufacturing processes. For example, improved manufacturing processes may result in decreased printhead-to-printhead variations. As more and more of these newer printheads 122 are deployed within the fleet 500, the printhead-to-printhead standard deviation will naturally decrease, thus exposing more outliers (e.g., those more than three sigma from the mean). Thus, the standard for non-conforming printheads 122 will naturally track manufacturing changes as new components are deployed within the fleet 500. The same may be true for other parameters, such as average ink drop size. That is, if manufacturing changes result in an increase or decrease in such a parameter, fleet-wide monitoring will naturally track that shift as new components are deployed within the fleet 500.

In some examples, analysis system 510 performs a statistical analysis on the non-linear coefficients for all printhead 122 of the fleet 500 of print devices 100. That is, analysis system 510 may analyze aspects of printhead 122 that are unrelated to average drop size, e.g., to tease out and/or reveal information unrelated to drop variation. The non-linear coefficients may indicate issues associated with the stitch zones between printheads, including latent maintenance issues, such as alignment. In some examples, analysis system 510 excludes, from this analysis, non-linear coefficients associated with inkjets that are located more than a threshold distance from the end of the printhead 122 and, thus, will have little or no effect on the stitch zone. For example, analysis system 510 may exclude TRCs associated with inkjets that are located more than 1 percent of the width of the printhead 122 away from the end of the printhead 122. Similar to the statistical analysis with respect to the calibration factors for each printhead, the analysis system 510 may perform a statistical analysis of the non-linear coefficients associated with each stitch zone to identify statistical outliers that may indicate latent maintenance issues. Statistically significant outliers may indicate a greater likelihood of a maintenance issue related to the stitch zone, such as a high degree of skew between adjacent printheads 122 associated with the stitch zone.

Similar to the approach described above for analyzing the correction factors, analysis system 510 combine the non-linear coefficients for included inkjets, e.g., by computing the median, arithmetic mean, weighted mean, or other value that represents the combined contribution of the individual non-linear coefficients of included inkjets of the printhead 122. The resulting overall non-linear coefficients for the printhead 122 may represent an overall indication of issues related to the corresponding stitch zone. Alternatively (or additionally), analysis system 510 may analyze the individual non-linear coefficients for included inkjets.

As described above, at least a portion of the non-linear coefficients may indicate potential maintenance issues, such as (excessive) misalignment between adjacent printheads 122. Some portion of the non-linear coefficients may be due to routine aspects of printer assemblies 120 that include multiple printheads 122. For example, some printheads 122 may be offset from other printheads 122 in the process direction, such that the ink from adjacent printheads 122 may arrive at the substrate at different times. Therefore, the ink from one printhead 122 may have somewhat more time to dry before the ink from the adjacent printhead arrives. For example, referring to FIGS. 2 and 3, the middle printhead 122b is offset from the outer printheads 122a, 112c. This difference in drying time may lead to subtle, but expected, issues where the ink from the two printheads 122 interact. The analysis system 510 may be sensitive enough to detect this phenomenon. However, no maintenance is required. To a large extent, similarly situated components in other printheads 122 within the fleet 500 would be expected to experience the same phenomenon in a similar manner. Therefore, the differential-drying-time phenomenon would be expected to contribute similarly to the non-linear coefficient. By performing a statistical analysis, comparing the non-linear coefficients associated with each printhead 122 (or each inkjet) to other (e.g., similarly situated) components within the fleet 500 to detect outliers, the analysis system 510 may avoid flagging issues that are not addressable by maintenance.

In addition to misalignment, subtle motion quality variations of the substrate under the printheads 122 may be detected by the non-linear component. The root cause of motion issues may be related to gears, rollers, belts, couplings, etc., that may need cleaning or replacement. By comparing printheads 122 (or inkjets) to other, similarly situated, components (as described above) the analysis system 510 would be expected to detect these printhead-specific phenomenon and trigger an action.

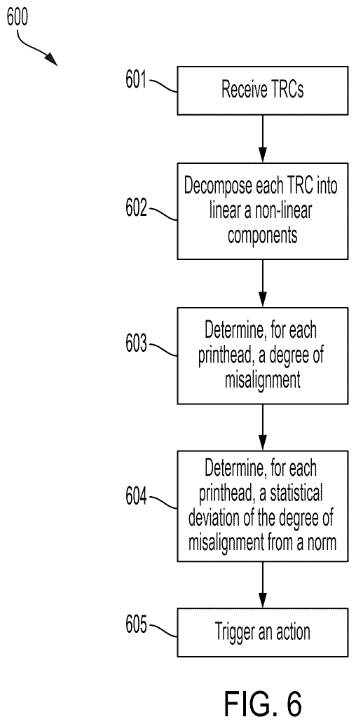

FIG. 6 shows a flowchart 600 of a method of detecting printhead 122 misalignment in a print device 100. At step 601, the method includes receiving, for each of multiple printheads 122, a tone response curves (TRC), each TRC associated with an inkjet of the printhead 122. In some examples, the printheads 122 include printhead of a fleet 500 of print devices 100. Each print device 100 in the fleet 500 may perform a density-optimization process from time to time to calibrate inkjets of the print device 100 so that a printed test pattern exhibits a high degree of uniformity (e.g., in intensity and color). The density-optimization process may result in TRCs which the print devices 100 may push to an analysis system 510 for processing.

At step 602, the method includes processing each of the TRCs to decompose each TRC into a linear component (e.g., correction factor) and a non-linear component. As described above, the linear component may be determined by applying an ordinary least-squares squares linear regression, and the non-linear component may be the residual after removing the linear component. Also, as disclosed above, linear and/or non-linear components for individual pixels and/or inkjets may be combined to determine overall linear and/or non-linear components for the printhead 122.

At step 603, the method includes determining, for each printhead, a degree of misalignment based on the non-linear component of the TRCs associated with the printhead 122. As described above, determining the degree of misalignment may include combining non-linear components of TRCs associated with select inkjets of the printhead 122 (e.g., inkjets near the end of the printhead 122). At step 604, the method includes determining, for each printhead 122, a statistical deviation of the degree of misalignment from a norm for the printheads 122. As described above, determining the statistical deviation may include performing a statistical analysis to determine, for each printhead 122, a deviation from the mean for all printheads 122 of the fleet 500.

At step 605, the method includes, in response to the statistical deviation of the degree of misalignment exceeding a misalignment threshold, triggering an action. As described above, actions may include making adjustments to the printhead (e.g., adjusting the cross-process position of the printhead 122, the roll of the printhead around an axis that is parallel to the cross-process direction, and/or a delay related to firing signals to inkjets of the printhead 122), making adjustments to the control of individual inkjets of the printhead 122 (e.g., making adjustments to the halftoning process to accommodate an off-normal droplet size), initiating a calibration or re-registration process, and/or providing an alert, causing a maintenance operation to be performed.

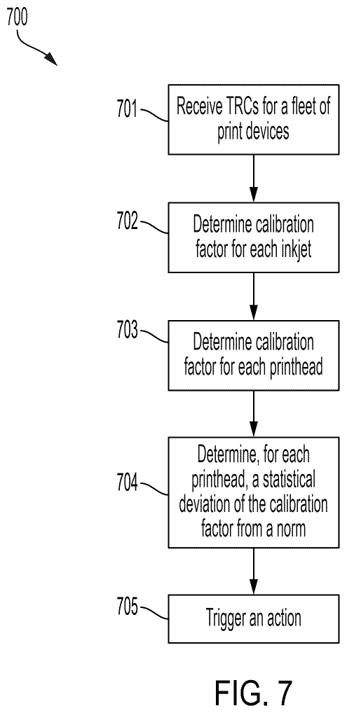

FIG. 7 shows a flowchart 700 of another example method. At step 701, the method includes receiving, for each of multiple printheads 122 of a fleet of print devices 100, a spatially varying tone response curve (sTRC), each sTRC including calibration information for each of multiple inkjets of the printhead 122. As described above, the sTRCs may be produced by the print devices. That is, each print device may use each printhead 122 to print a test pattern on a substrate, capture an image of each printed test pattern, and process the captured images to generate the sTRCs for the printheads 122.

At step 702, the method includes applying a linear regression to the calibration information for each inkjet to determine a calibration factor for each inkjet. In some examples, applying the linear regression includes applying a simple linear regression, e.g., applying an ordinary least-squares process to minimize the aggregate residual. The resulting calibration factor may represent a typical correction applied to the inkjet in order to achieve uniformity. Thus, the inkjet correction factors may be compared to each other for an understanding of the relative corrections applied to each inkjet.

At step 703, the method includes, based on one or more of the calibration factors, determining an overall calibration factor for each of the multiple printheads 122. The overall calibration factor may be an average or a weighted average of the calibration factors for each inkjet. In some examples, the overall calibration factor for the printhead 122 only includes the calibration factors associated with particular inkjets. For example, the method may exclude inkjets associated with a stich zone between adjacent printheads 122. The calibration factors associated with these inkjets may be affected by factors such as misalignment of the adjacent printhead 122, which may be unrelated to an overall calibration of the printhead 122.

At step 704, the method includes determining, for each printhead, a statistical deviation of its overall calibration factors from a norm for the multiple printheads 122. In some examples, determining a deviation from a norm includes determining a statistical variance from the mean value of calibration factors for printheads in the fleet of print devices 100. At step 705, the method includes, in response to the statistical deviation of the overall calibration factor exceeding a calibration threshold, triggering an action. The action may include replacing the printhead 122 or swapping the position of the printhead 122 within its printer assembly 120.

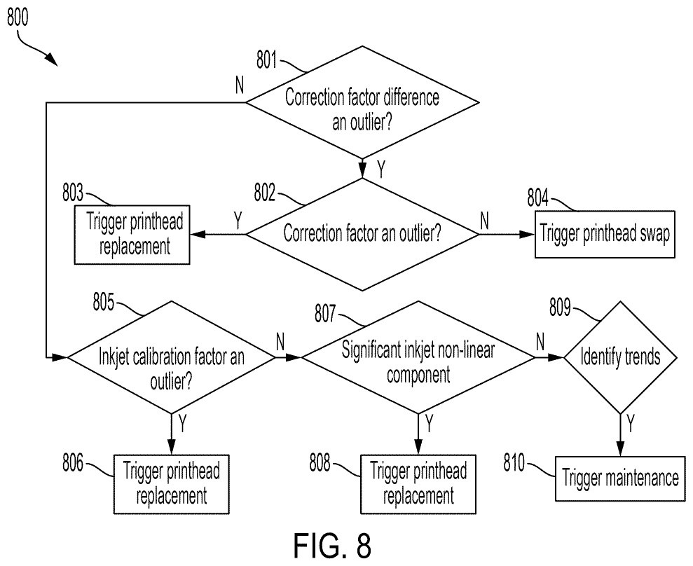

FIG. 8 shows a flowchart 800 of an example service decision tree based on the determinations by the analysis system 510. At step 801, the analysis system 510 determines whether the difference between correction factors of adjacent printheads 122 is an outlier for the fleet 500. In some examples, the analysis system 510 determines that the difference between correction factors of adjacent printheads 122 is an outlier when the difference is greater than a predefined threshold. In other examples, the analysis system 510 determines that the difference between correction factors of adjacent printheads 122 is an outlier when the difference exceeds a predefined degree of variance (e.g., three sigma) for the fleet of print devices 100. If so, the decision tree continues at step 802, where the analysis system 510 determines whether the correction factor for one of the adjacent printheads is also an outlier for the fleet 500. That determination may indicate that the large difference is due to a bad printhead 122. If so, the decision tree continues at step 803, where the analysis system 510 triggers replacing the outlier printhead 122. If the analysis system 510 detects that the correction factors for each of the adjacent printheads are not outliers (i.e., are both within a threshold of the norm for the fleet 500), the decision tree continues at step 804, where the analysis system 510 triggers reordering the printheads 122 within the print assembly 120. By reordering the printheads 122, the difference between any two printheads 122 within the print assembly 120 is minimized, reducing large changes at the stitch zone.

At step 805, the analysis system 510 determines whether a particular inkjet within a printhead 122 has an associated correction factor which is an outlier. That is, even if the overall correction factor for the printhead 122 is not an outlier, the correction factor for an individual inkjet may be, and this may indicate a defective inkjet. The analysis system 510 may determine that the individual correction factor is a statistical outlier for inkjets of the fleet (e.g., more than three sigma from a mean for the fleet), or may determine that the individual correction factor is outside of a predetermined range of correction factors. In either case, the method continues at step 806, triggering replacement of the printhead 122.

At step 807, the analysis system 510 determines whether a particular inkjet within a printhead 122 has associated calibration information (such as a TRC) with a significant non-linear component. As described above, a significant non-linear component may be expected for inkjets within the stitch zone between printheads 122. However, a particular inkjet that is not within a stitch zone but which does have calibration information with a significant non-linear component, may be defective. The analysis system 510 may determine that the non-linear component is a statistical outlier for inkjets of the fleet (e.g., more than three sigma from a mean for the fleet), or may determine that the non-linear component is outside of a predetermined range of non-linear components. In either case, the method continues at step 808, triggering replacement of the printhead 122.

At step 809, the analysis system 510 monitors any or all of the parameters described above over time to predict future values. For example, the analysis system 510 may monitor the overall calibration factors for each printhead 122 of the fleet of print devices 100. The analysis system 510 may determine a rate of change of the overall calibration factor for each printhead 122. Based on this determination, the analysis system 510 may predict, in advance, when a printhead 122 may become an outlier. Based on the prediction, the analysis system 510 may trigger (e.g., at step 810) an appropriate maintenance activity, such as proactively replacing the printhead 122 at a convenient time, such as a known idle time of the print device 100. The analysis system 510 may also monitor any other measured and/or computed values, predict the trajectory of the value, and determine appropriate maintenance activities based on the value and/or the trajectory. In each of these cases, the method continues at step 810 with triggering the appropriate maintenance activity.

As discussed above, software associated with print device 100, including calibration software and including software associated with operating components of print device 100, may be executed on a system similar to computing device 900. Computing device 900 may include more or less components than those shown in FIG. 9. However, the components shown are sufficient to disclose an illustrative solution implementing the present solution. The hardware architecture of FIG. 9 represents one implementation of a representative computing device configured to receive information, process the received information, transmit information and/or control operations of a print device, as described herein. As such, the computing device 900 of FIG. 9 implements at least a portion of the method(s) described herein.

Some or all components of the computing device 900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 9, the computing device 900 includes a user interface 902, a Central Processing Unit (CPU) 906, a system bus 910, a memory 912 connected to and accessible by other portions of computing device 900 through system bus 910, a system interface 960, and hardware entities 914 connected to system bus 910. The user interface can include input devices and output devices, which facilitate user-software interactions for controlling operations of the computing device 900. The input devices include, but are not limited to, a physical and/or touch keyboard 950. The input devices can be connected to the computing device 900 via a wired or wireless connection (e.g., a Bluetooth® connection). The output devices include, but are not limited to, a speaker 952, a display 954, and/or light emitting diodes 956. System interface 960 is configured to facilitate wired or wireless communications to and from external devices (e.g., network nodes such as access points, etc.).

At least some of the hardware entities 914 perform actions involving access to and use of memory 912, which can be a Random Access Memory (RAM), a disk drive, flash memory, a Compact Disc Read Only Memory (CD-ROM) and/or another hardware device that is capable of storing instructions and data. Hardware entities 914 can include a disk drive unit 916 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the computing device 900. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the computing device 900 and that cause the computing device 900 to perform any one or more of the methodologies of the present disclosure.

The following paragraphs provide additional information about various terms used in this document:

In this document, the term “approximately,” when used in connection with a numeric value, is intended to include values that are close to, but not exactly, the number. For example, in various embodiments, the term “approximately” may include values that are within +/−1 percent of the value, +/−5 percent of the value, +/−10 percent of the value, or any value or fraction thereof between any or all of the values.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

As used in this document, the singular form “a”, “an”, and “the” include plural references unless the context clearly dictates otherwise. Unless defined otherwise, all technical and scientific terms used herein have the same meaning as commonly understood by one of ordinary skill in the art. As used in this document, the term “comprising” means “including, but not limited to.”

The terms “printer” and “print device” refer to a machine having hardware capable of reading digital data and using the information from the data and associated print instructions to print a physical document on a substrate. In some embodiments, a print device may have additional capabilities such as scanning or faxing and thus may be a multifunction device. Example print devices include traditional printers and multifunction devices, as well as specialized print devices such as ticket printers, sales receipt printers, and the like. Components of a print device typically include a print engine, as well as a document feeding system configured to pass a substrate through the print device so that the printhead or printheads of the print engine can print characters and/or images on the substrate.

The term “print engine” refers to the marking hardware of a print device, such as a print head, along with marking material storage and delivery components such as a print cartridge containing ink, toner or another marking material. A print engine also includes conveyors, rollers or other media transport components that are configured to move a substrate past the print head to receive printed images onto the substrate. The print engine also may include a control system that controls the operation of the hardware described above. In an inkjet printing system, the marking material storage and delivery components may include one or more print heads arranged in a print zone and that eject ink drops onto the substrate.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The term “processor” refers to electronic device hardware that is configured to execute programming instructions. The term “processor” may refer to either a single processor or to multiple processors that together implement various steps of a process. Unless the context specifically states that a single processor is required or that multiple processors are required, the term “processor” includes both the singular and plural embodiments.

The terms “memory,” “memory device,” “computer-readable medium” and “data store” each refer to a non-transitory device on which computer-readable data, programming instructions or both are stored. Unless the context specifically states that a single device is required or that multiple devices are required, the terms “memory,” “memory device” “computer-readable medium” and “data store” include both the singular and plural embodiments, as well as portions of such devices such as memory sectors.

This disclosure is not limited to the particular systems, methodologies or protocols described, as these may vary. The terminology used in this description is for the purpose of describing the particular versions or embodiments only and is not intended to limit the scope.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

The described features, advantages, and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such a feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method of detecting printhead misalignment in a print device, the method comprising, by a processor:
receiving, for each of a plurality of printheads, a plurality of tone response curves (TRCs), each TRC associated with an inkjet of the printhead;
processing each of the plurality of TRCs to decompose each TRC into a linear component and a non-linear component;
determining, for each printhead, a degree of misalignment based on the non-linear component of the TRCs associated with the printhead;
determining, for each printhead, a statistical deviation of the degree of misalignment from a norm for the plurality of printheads; and
in response to the statistical deviation of the degree of misalignment exceeding a misalignment threshold, triggering an action.

2. The method of claim 1, further comprising:
monitoring, for each printhead of the plurality of printheads, changes in the degree of misalignment over time; and
in response to a change in the degree of misalignment exceeding a change threshold, triggering a second action.

3. The method of claim 1, wherein receiving the plurality of TRCs comprises receiving TRCs for each printhead of a fleet of print devices.

4. The method of claim 1, wherein triggering the action comprises causing re-registration of one or more of the printheads.

5. The method of claim 1, wherein receiving the plurality of TRCs comprises receiving TRCs associated with inkjets corresponding to a stitch zone between printheads.

6. The method of claim 1, wherein:
the plurality of printheads comprise printheads of a plurality of print devices, the plurality of print devices comprising a fleet of print devices; and
determining the statistical deviation of the degree of misalignment from the norm for the plurality of printheads comprises determining a statistical deviation of the degree of misalignment from a norm for the fleet of print devices.

7. The method of claim 6, wherein:
the norm for the fleet of print devices comprises a mean of the degrees of misalignment for printheads of the fleet of print devices; and
the misalignment threshold comprises three standard deviations from the mean for the fleet of print devices.

8. The method of claim 1, further comprising, by the print device:
using each printhead to print a test pattern on a substrate;
capturing an image of each printed test pattern; and
processing the captured images to generate the TRCs for the printheads.

9. The method of claim 1, wherein:
each printhead comprises a printhead of one or more printer assemblies of a fleet of print devices;
each of the one or more printer assemblies of the fleet of print devices comprises a plurality of printheads; and
determining, for each printhead, a degree of misalignment comprises determining a degree of misalignment with respect to an adjacent printhead of the printer assembly.

10. A method comprising, by a processor:
receiving, for each of a plurality of printheads of a fleet of print devices, a spatially varying tone response curve (sTRC), the sTRC comprising calibration information for each of a plurality of inkjets of the printhead;
applying a linear regression to the calibration information for each inkjet to determine a calibration factor for each inkjet;
based on one or more of the calibration factors, determining an overall calibration factor for each of the plurality of printheads;
determining, for each printhead, a statistical deviation of its overall calibration factors from a norm for the plurality of printheads; and
in response to the statistical deviation of the overall calibration factor exceeding a calibration threshold, triggering an action.

11. The method of claim 10, wherein determining the overall calibration factor for each of the plurality of printheads comprises:
determining whether each inkjet is associated with a stitch zone; and
averaging the calibration factors for inkjets that are not associated with the stitch zone.

12. The method of claim 11, wherein determining whether each inkjet is associated with a stitch zone comprises:
after determining the calibration factor for each inkjet, determining a non-linear coefficient for each inkjet based on residual calibration information; and
in response to the non-linear coefficient exceeding a threshold, determining that the inkjet is associated with the stitch zone.

13. The method of claim 10, further comprising:
after determining the calibration factor for each inkjet, determining a non-linear coefficient based on residual calibration information;
determining whether each inkjet is associated with a stitch zone based on a position of the inkjet in the printhead; and
in response to an inkjet that is not associated with a stitch zone having a non-linear component that exceeds a threshold, triggering a second action.

14. The method of claim 10, further comprising:
determining, for each inkjet of each printhead, a statistical deviation of its calibration factor from a norm for the inkjets of the printhead; and
in response to the statistical deviation of the calibration factor exceeding an inkjet calibration threshold, triggering a second action.

15. The method of claim 10, further comprising:
determining, for each printhead, a rate of ink usage based on the overall calibration factor for the printhead.

16. The method of claim 15, further comprising:
determining, for each printhead, a statistical deviation of the rate of ink usage from the norm for the plurality of printheads.

17. The method of claim 16, further comprising:
in response to the statistical deviation of the rate of ink usage exceeding a usage threshold, triggering a second action.

18. The method of claim 17, wherein triggering the second action comprises adjusting a voltage applied to one or more of the printheads having the rate of ink usage exceeding the usage threshold.

19. The method of claim 17, wherein triggering the second action comprises adjusting a halftoning process associated with one or more inkjets of one or more of the printheads having the rate of ink usage exceeding the usage threshold.

20. The method of claim 10, further comprising, by at least one print device of the fleet of print devices:
using each printhead to print a test pattern on a substrate;
capturing an image of each printed test pattern; and
processing the captured images to generate the sTRCs for the printheads.
